(19) United States
(12) Patent Application Publication
(10) Pub. No.: US 2020/0076011 A1
(43) Pub. Date: Mar. 5, 2020

(54) BATTERY CHARGING SYSTEM AND METHOD

(71) Applicants: Hyundai Motor Company, Seoul (KR); Kia Motors Corporation, Seoul (KR)

(72) Inventors: Yong Hwan Choi, Yongin (KR); Yong Jin Lee, Hwaseong (KR); Tae Hyuck Kim, Cheonan (KR); Jeong Hun Seo, Suwon (KR); Hae Kyu Lim, Bucheon (KR)

(21) Appl. No.: 16/199,969

(22) Filed: Nov. 26, 2018

(30) Foreign Application Priority Data
Aug. 31, 2018 (KR) 10-2018-0103906

(51) Int. Cl. H01M 10/44; H02J 7/00; H02J 7/14

(52) U.S. Cl. CPC H01M 10/445; H02J 7/009; H01M 2200/20; H02J 7/14; H02J 7/0027

(57) ABSTRACT

A battery charging system including a battery is provided. The battery includes a plurality of battery cells that are stacked and a pressure sensor that is configured to detect a pressure caused by swelling of the battery cells. A charger supplies charging power to the battery and a controller determines whether to supply the charging power from the charger and whether the battery is overcharged based on a change in the pressure per hour, detected by the pressure sensor, when the charger supplies the charging power to the battery.

### CROSS-REFERENCE TO RELATED APPLICATION

This application claims the priority benefit of Korean Patent Application No. 10-2018-0103906, filed on Aug. 31, 2018, the disclosure of which is incorporated herein by reference.

### BACKGROUND

### 1. Field of the Invention

The present invention relates to a battery charging system and method, and more particularly to a battery charging system and method, which diagnoses the cause of swelling in a battery cell within a battery during the charging and determines whether the battery is overcharged based on the diagnosed cause.

### 2. Description of the Related Art

As the problems of global warming and environmental pollution increase, research and development into eco-friendly vehicles that are capable of minimizing environmental pollution is being actively conducted in the automotive industry field, and markets thereof are gradually expanding. Examples of such eco-friendly vehicles include an electric vehicle, a hybrid electric vehicle, and a plug-in hybrid electric vehicle, to which an electric motor is used to generate drive power using electricity rather than using an existing internal combustion engine, which generates drive power via combustion of fossil fuels. Among these eco-friendly vehicles using electricity, the electric vehicle and the plug-in hybrid electric vehicle charge a battery installed within the vehicle upon receiving power from an external charging facility connected to a grid, and generate kinetic energy required for the driving of the vehicle using the power charged in the battery.

The battery installed within the vehicle includes a plurality of battery cells, each of which outputs a low voltage and the battery cells are connected in series to output a desired magnitude of voltage. During the charging of the battery, the swelling phenomenon, in which the battery cells swell, occurs due to various reasons. For example, one of the reasons for the swelling may be deterioration in the durability of the battery. In other words, when the battery is used for a long period of time, the battery cells may swell during the charging of the battery even if the battery is charged normally. Such swelling due to deterioration in durability may become more severe for a given amount of charge as the service life is prolonged. Another reason for the battery swelling phenomenon may be overcharging of the battery.

Conventionally, a method of measuring the surface pressure inside a battery caused by the swelling of battery cells during the charging of the battery and determining that overcharging of the battery occurs when the surface pressure becomes a preset threshold or more to thereby stop the charging has been applied. This conventional charging method, however, merely compares the surface pressure of the battery with the threshold, and therefore, may cause erroneous interruption of charging of the battery by determining the occurrence of overcharging even though the battery is normally charged when the surface pressure is increased during charging due to deterioration in the durability of the battery.

Details described as the background art are intended merely for the purpose of promoting the understanding of the background of the present invention and should not be construed as an acknowledgment of the prior art that is not known to those of ordinary skill in the art.

### SUMMARY

The present invention provides a battery charging system and method, which are capable of more accurately determining whether a battery is overcharged based on a change in the surface pressure inside the battery due to the swelling of battery cells during the charging of the battery, thereby enabling appropriate measures to be taken.

In accordance with an aspect of the present invention, a battery charging system including a battery may include a plurality of battery cells stacked one above another and a pressure sensor configured to detect a pressure caused by swelling of the battery cells, a charger configured to supply charging power to the battery, and a controller configured to adjust supply of the charging power from the charger and to determine whether the battery is overcharged based on a change in the pressure per hour, detected by the pressure sensor, when the charger supplies the charging power to the battery.

The battery may further include an end plate disposed on an outermost edge in a direction in which the battery cells are stacked, and the pressure sensor may be a film-type surface-pressure sensor disposed between the end plate and the battery cell adjacent thereto. The controller may be configured to operate the charger to stop the supply of the charging power when the pressure detected by the pressure sensor is equal to or greater than a threshold pressure, which is preset to prevent damage to the battery cells.

The controller may be configured to output a warning message when the pressure detected by the pressure sensor is equal to or greater than the threshold pressure. Additionally, the controller may be configured to determine that the battery is in an overcharged state when the change in the pressure per hour, detected by the pressure sensor, is greater than a preset reference value, and may be configured to determine that the battery is in a normal state when the change in the pressure per hour, detected by the pressure sensor, is equal to or less than the preset reference value. The controller may be configured to operate the charger to stop the supply of the charging power when determining that the battery is in the overcharged state.

In accordance with another aspect of the present invention, a battery charging method may include supplying charging power to a battery, detecting a pressure between battery cells inside the battery, and determining whether the battery is overcharged based on a change in the pressure per hour, detected by a pressure sensor, when the charging power is supplied from a charger to the battery.

The determining whether the battery is overcharged may include comparing the pressure detected by the pressure sensor with a threshold pressure, which is preset to prevent damage to the battery cells. In addition, the determining of whether the battery is overcharged may include stopping the supply of the charging power when the pressure detected by the pressure sensor is equal to or greater than the threshold pressure. The battery charging method may further include outputting a warning message when the pressure detected by the pressure sensor is equal to or greater than the threshold pressure.

The battery may be determined to be in an overcharged state when the change in the pressure per hour, detected by the pressure sensor, is greater than a preset reference value. Additionally, the battery may be determined to be in a normal state when the change in the pressure per hour, detected by the pressure sensor, is equal to or less than the preset reference value. The supply of the charging power may be stopped in response to determining that the battery is in the overcharged state.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating the configuration of a battery charging system according to an exemplary embodiment of the present invention;

FIG. 2 is a cross-sectional view of a battery constituting the battery charging system according to the exemplary embodiment of the present invention;

FIG. 3 is a detailed perspective view of the battery constituting the battery charging system according to the exemplary embodiment of the present invention;

FIG. 4 is a flowchart illustrating a battery charging method according to the exemplary embodiment of the present invention;

FIG. 5 is a graph illustrating a normal change in the surface pressure caused by deterioration in the durability of the battery in the battery charging system and method according to the exemplary embodiment of the present invention; and

FIG. 6 is a graph illustrating a change in the surface pressure caused by overcharging of the battery in the battery charging system and method according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, a battery charging system and method according to various exemplary embodiments of the present invention will be described below in more detail with reference to the accompanying drawings.

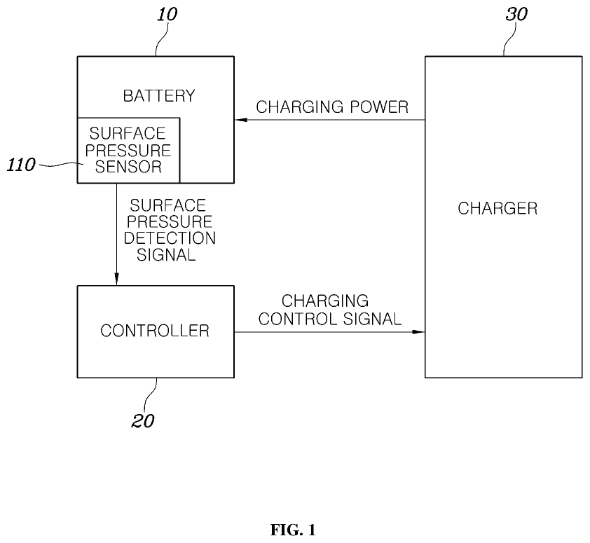

FIG. 1 is a block diagram illustrating the configuration of a battery charging system according to an exemplary embodiment of the present invention. Referring to FIG. 1, the battery charging system according to the exemplary embodiment of the present invention may include a battery 10, a charger 30 configured to provide charging power to the battery 10, and a controller 20 configured to determine whether the battery 10 is overcharged based on the pressure between battery cells provided inside the battery 10. The battery 10 is an energy storage device configured to store electricity therein, and may be a module or a package including a plurality of battery cells. In the description and the claims of the present invention, the term “battery” should be understood as having a meaning including a battery module or a battery package including a plurality of battery cells.

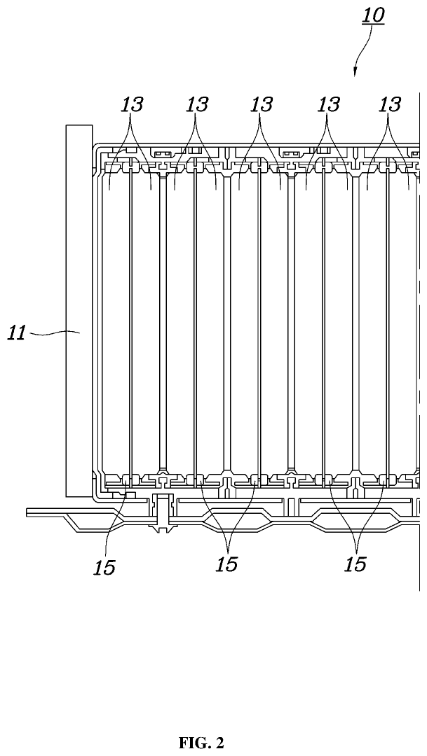

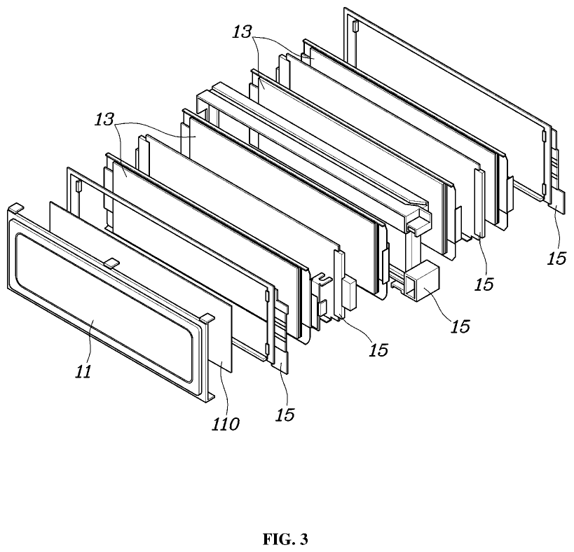

FIG. 2 is a cross-sectional view of a battery of the battery charging system according to the exemplary embodiment of the present invention, and FIG. 3 is a detailed perspective view of the battery of the battery charging system according to the exemplary embodiment of the present invention. Referring to FIGS. 2 and 3, the battery 10, which is mainly applied to a vehicle, may include a plurality of battery cells 13 stacked in a given direction to come into surface contact with each other, and an end plate 11, which is formed of hard plastics, for example, may be disposed on the outermost edge of the stack of the battery cells 13. In addition, the battery 10 may further include a fixing structure 15, such as a frame, for maintaining the arrangement of the battery cells 13. In other words, the fixing structure may provide stability to the battery configuration.

The stack of the battery cells 13 in surface contact with each other may maximize the storage density of electricity. The end plate 11 may be fixedly disposed on the outermost edge of the stack of the battery cells 13 to apply the surface pressure to the center of the stack of the battery cells 13. In other words, the hard end plate 11 may support the outermost edge of the stack of the battery cells 13, thereby preventing the swelling of the battery cells 13. The battery cells 13 may evenly divide and output the voltage to be output from the battery 10 based on the number thereof (e.g., based on the number of battery cells). The output voltage of the battery 10 may be generated via serial connection of the battery cells 13. To increase the capacity of the battery 10, two or more structures, each of which includes the plurality of battery cells 13 connected in series to generate the output voltage of the battery 10, may be connected in parallel.

With the arrangement of the battery cells 13 in the battery 10, when the swelling of the battery cells 13 occurs for various reasons while charging current is being supplied to the battery cells 13 during the charging of the battery, the pressure between the battery cells 13, which are in surface contact with each other, may increase. In other words, by measuring the surface pressure formed by the battery cells 13, it may be possible to determine whether battery swelling occurs and to determine the degree of swelling based on the magnitude of the surface pressure. Typically, the battery cell 13 is formed as a pouch, and the outer surface thereof may be deformed. In other words, it may be difficult to constantly measure the pressure acting on a specific point between two battery cells 13 due to the deformation of the pouch-shaped battery cells 13.

Accordingly, in the exemplary embodiment of the present invention, a sensor 110 may be provided to measure the pressure between the battery cell, which is disposed on the outermost edge of the stack of the battery cells 13, and the hard end plate 11, which is in surface contact with the outermost battery cell. Since the surface of the hard end plate 11, which is in contact with the battery cell, is not deformed, the pressure attributable to the swelling of the battery cells 13 may be measured consistently. In particular, due to the structural characteristics of the surface contact between the end plate 11 and the battery cells 13 and to prevent an increase in the volume of the battery 10 due to the provision of the sensor for measuring the pressure, the pressure sensor may be a film-type surface-pressure sensor 110. During the charging of the battery 10, the pressure detected by the film-type surface-pressure sensor 110 may be continuously supplied to the controller 20.

The charger 30 may be configured to supply charging power to the battery 10. For an eco-friendly vehicle, the charger 30 may be an on-board charger (OBC) configured to convert alternating current (AC) power supplied from a charging facility extraneous to the vehicle to output a direct current (DC) voltage and DC current required for the charging of the battery 10. The charger applied to the battery charging system according to various exemplary embodiments of the present invention may be a charger or an electric/electronic charging circuit, which is employed in fields other than that of vehicles.

The charger 30 may be operated based on a charging control signal provided from the controller 20 to selectively supply charging power. In various exemplary embodiments of the present invention, the charging control signal may be mainly understood as a signal for determining whether to supply charging power. The controller 20 may be configured to receive a surface pressure detection signal that indicates the pressure formed by the battery cells 13 in the battery 10 from the pressure sensor (or the surface pressure sensor) 110 disposed within the battery 10, and may be configured to determine whether the battery 10 is overcharged based on a change in the detected pressure per hour.

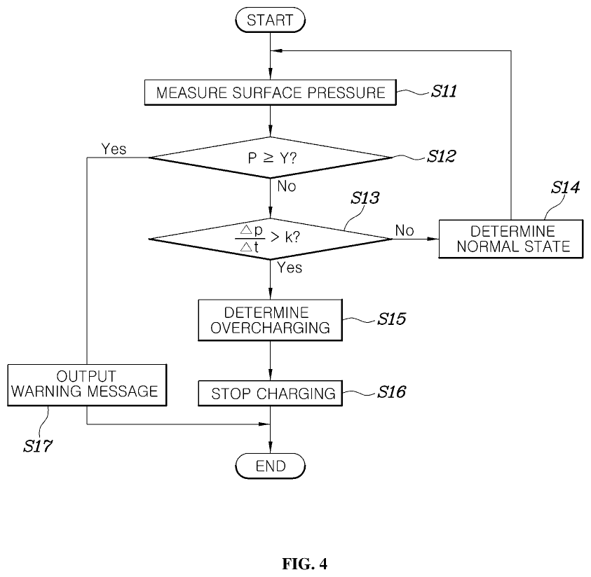

The operation and action of the battery charging system according to the exemplary embodiment of the present invention, executed by the controller 20, will be further clearly understood from the description related to the battery charging method according to the exemplary embodiment of the present invention. FIG. 4 is a flowchart illustrating a battery charging method according to the exemplary embodiment of the present invention. Referring to FIG. 4, the battery charging method according to the exemplary embodiment of the present invention may include measuring the pressure caused by the swelling of the battery cells 13 using the pressure sensor (e.g., the film-type surface-pressure sensor) 110 after initiating charging to cause the charger 30 to supply charging power to the battery 10 under the operation of the controller 20 (S11).

Thereafter, the controller 20 may be configured to continuously receive information regarding the pressure detected by the pressure sensor 110 and compare the magnitude P of the received pressure with a preset threshold pressure Y (S12). The threshold pressure Y is a value that is set in advance to prevent damage to the battery cells 13. By detecting that the pressure of the battery cells 13 has already been increased to a pressure that may cause damage to the battery cells 13 regardless of a change in the pressure per hour, it may be possible to prevent damage to the battery 10.

In step S12, when the controller 20 detects that the pressure P detected by the pressure sensor 110 is equal to or greater than the threshold pressure Y, the controller 20 may be configured to output a warning message using various methods (e.g., generation of a warning sound or lighting of a warning lamp) and may operate the charger 30 to immediately stop the supply of charging power. In step S12, when the controller 20 detects that the pressure P detected by the pressure sensor 110 is less than the threshold pressure Y, the controller 20 may be configured to calculate a change in the pressure per hour Δp/Δt and compare the change in the pressure with a preset reference value k (S13). The cause of the swelling of the battery cells 13, which occurs during the charging of the battery 10, may be deterioration in the durability of the battery 10, i.e. deterioration in the battery 10 that gradually occurs as the use period of the battery 10 increases, or may be the overcharging of the battery 10.

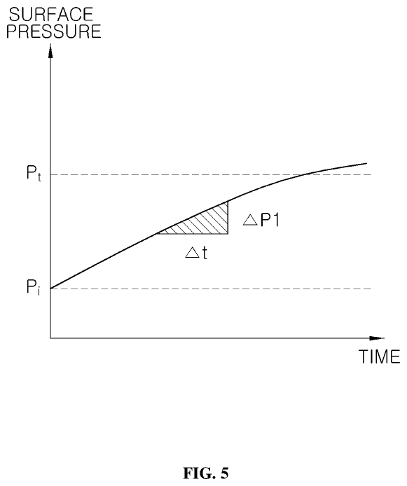

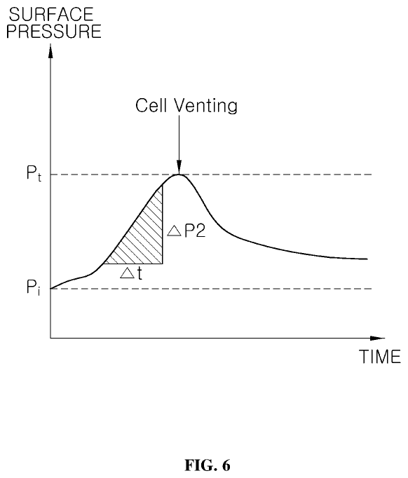

FIG. 5 is a graph illustrating a normal change in the surface pressure caused by deterioration in the durability of the battery in the battery charging system and method according to the exemplary embodiment of the present invention, and FIG. 6 is a graph illustrating a change in the surface pressure caused by the overcharging of the battery in the battery charging system and method according to the exemplary embodiment of the present invention. As illustrated in FIG. 5, since the swelling due to deterioration in the durability of the battery 10 gradually increases as the charging time of the battery 10 increases, the pressure measured by the pressure sensor 110 also gradually increases as time passes.

Conversely, as illustrated in FIG. 6, since the swelling due to the overcharging of the battery 10 rapidly increases within a relatively short period of time, the pressure measured by the pressure sensor 110 also increases rapidly. When overcharging is determined based on the value of the pressure, as in the related art, when swelling due to deterioration in durability occurs, as illustrated in FIG. 5, the state of the battery 10 may be incorrectly diagnosed as the overcharged state even through overcharging does not occur. Thus, charging may stop based on the determination of overcharging even though it may be possible to perform further charging.

Accordingly, the battery charging system and method according to various exemplary embodiments of the present invention have a feature in that whether overcharging occurs may be determined by comparing a change in the pressure per hour with a preset reference value, rather than simply determining the occurrence of overcharging based on the magnitude of a reference pressure. Accordingly, when determining whether overcharging occurs by comparing a change in the pressure per hour with a preset reference value, according to the present invention, overcharging may be initially determined before the pressure of the battery increases beyond a predetermined level. As a result, it may be possible to enhance the safety of the battery by shutting off the charging current of the battery before the pressure reaches a pressure at which venting due to damage to the battery cell occurs. In addition, it may be possible to prevent the charging of the battery from being incorrectly stopped even though the battery may perform further charging by distinguishing an increase in pressure caused by deterioration in the durability of the battery from an increase in pressure caused by the overcharging of the battery.

When a change in the pressure per hour is equal to or less than a preset reference value in step S13, the controller 20 may be configured to determine that the battery 10 is in the normal state (S14) to thus operate the charger 30 to continuously supply charging power. Conversely, in response to determining that a change in the pressure per hour is greater than the preset reference value in step S13, the controller 20 may be configured to diagnose that the battery 10 is in the overcharged state (S15) to thus stop charging by shutting off the supply of charging power (S16).

As is apparent from the above description, according to the battery charging system and method, since whether a battery is overcharged based on a change in the pressure per hour caused by the swelling of battery cells in the battery, it may be possible to solve the problem of not being able to distinguish between the occurrence of swelling due to deterioration in the durability of the battery and the occurrence of swelling due to overcharging of the battery, unlike the related art in which overcharging is determined based only on the magnitude of pressure. In other words, according to the battery charging system and method, it may be possible to more accurately determine whether the battery is overcharged, and consequently, to advantageously secure the safety of the battery against overcharging and to prevent the charging of the battery from being incorrectly stopped when swelling occurs due to deterioration in durability even though the battery may perform further charging. In addition, according to the battery charging system and method, since the overcharging may be determined based on a change in the pressure per hour, it may be possible to diagnose the overcharging of the battery at an early stage before the pressure of the battery increases to a certain level or greater, and consequently, to further improve the safety of the battery.

Although the exemplary embodiments of the present invention have been described above with reference to the accompanying drawings, those skilled in the art will appreciate that the present invention can be implemented in various other exemplary embodiments without changing the technical ideas or features thereof.

What is claimed is:

1. A battery charging system, comprising:
a battery include a plurality of stacked battery cells and a pressure sensor configured to detect a pressure caused by swelling of the battery cells;
a charger configured to supply charging power to the battery; and
a controller configured to determine whether to supply the charging power from the charger and whether the battery is overcharged based on a change in the pressure per hour, detected by the pressure sensor, when the charger supplies the charging power to the battery.

2. The battery charging system according to claim 1, wherein the battery further includes:
an end plate disposed on an outermost edge in a direction in which the battery cells are stacked,
wherein the pressure sensor is a film-type surface-pressure sensor disposed between the end plate and the battery cell adjacent thereto.

3. The battery charging system according to claim 1, wherein the controller is configured to operate the charger to stop the supply of the charging power when the pressure detected by the pressure sensor is equal to or greater than a threshold pressure, which is preset to prevent damage to the battery cells.

4. The battery charging system according to claim 3, wherein the controller is configured to output a warning message when the pressure detected by the pressure sensor is equal to or greater than the threshold pressure.

5. The battery charging system according to claim 1, wherein the controller is configured to determine that the battery is in an overcharged state when the change in the pressure per hour, detected by the pressure sensor, is greater than a preset reference value, and determine that the battery is in a normal state when the change in the pressure per hour, detected by the pressure sensor, is equal to or less than the preset reference value.

6. The battery charging system according to claim 1, wherein the controller is configured to operate the charger to stop the supply of the charging power when determining that the battery is in the overcharged state.

7. The battery charging system according to claim 5, wherein the controller is configured to operate the charger to stop the supply of the charging power when determining that the battery is in the overcharged state.

8. A battery charging method, comprising:
supplying, by a controller, charging power to a battery;
detecting, by the controller, a pressure between battery cells inside the battery; and
determining, by the controller, whether the battery is overcharged based on a change in the pressure per hour, which is detected by a pressure sensor, when the charging power is supplied from a charger to the battery.

9. The battery charging method according to claim 8, wherein the determining of whether the battery is overcharged includes:
comparing, by the controller, the pressure detected by the pressure sensor with a threshold pressure, which is preset to prevent damage to the battery cells; and
stopping, by the controller, the supply of the charging power when the pressure detected by the pressure sensor is equal to or greater than the threshold pressure.

10. The battery charging method according to claim 9, further comprising:
outputting, by the controller, a warning message when the pressure detected by the pressure sensor is equal to or greater than the threshold pressure.

11. The battery charging method according to claim 8, further comprising:
determining, by the controller, that the battery is in an overcharged state when the change in the pressure per hour, detected by the pressure sensor, is greater than a preset reference value; and
determining, by the controller, that the battery is in a normal state when the change in the pressure per hour, detected by the pressure sensor, is equal to or less than the preset reference value.

12. The battery charging method according to claim 8, further comprising:
stopping, by the controller, the supply of the charging power in response to determining that the battery is in the overcharged state.

13. The battery charging method according to claim 11, further comprising:
stopping, by the controller, the supply of the charging power in response to determining that the battery is in the overcharged state.
